(19) United States
(12) Patent Application Publication
(10) Pub. No.: US 2026/0171446 A1
(43) Pub. Date: Jun. 18, 2026

(54) METHOD FOR STARTING A FUEL CELL SYSTEM

(71) Applicant: Robert Bosch GmbH, Stuttgart (DE)

(72) Inventor: Jochen Braun, Heimsheim (DE)

(21) Appl. No.: 19/108,636

(22) PCT Filed: Sep. 13, 2023
(86) PCT No.: PCT/EP2023/075138

§ 371 Date: Mar. 4, 2025

(30) Foreign Application Priority Data
Sep. 14, 2022 (DE) 10 2022 209 596.0

(51) Int. Cl. H01M 8/04223; H01M 8/04111; H01M 8/04746

(52) U.S. Cl. CPC H01M 8/04231; H01M 8/04111; H01M 8/04753

(57) ABSTRACT

A method for starting a fuel cell system is proposed, wherein the fuel cell system comprises at least one fuel cell stack and a compressor arrangement that has a first compressor, which is coupled to an electric motor, and a second compressor, which is coupled to a turbine arranged in a cathode path of the fuel cell system. The method can provide a first start mode and a second start mode, in which modes only the first compressor or both compressors is/are started, in particular depending on starting conditions and operating conditions of the fuel cell stack.

### BACKGROUND

The present invention relates to a method for starting a fuel cell system and a fuel cell system.

In vehicles in which at least part of the electrical power required for an electric drive is provided by a fuel cell system, compressors are usually integrated for compressing and supplying ambient air to the fuel cell system. Numerous different compressor assemblies are known, which are single-flow, double-flow, single-stage or multi-stage. Thermal turbomachines are often used as compressors. A two-stage compressor arrangement comprises, for example, a first compressor with an electric drive. A downstream or upstream second compressor could be driven by a turbine arranged in a cathode path and, in particular, an outgoing air path of the fuel cell system.

In some modes of operation or operating conditions, low cathode pressures in the range of the ambient pressure are required for fuel cells, particularly at low temperatures of the fuel cells, in order to sufficiently remove the water formed. However, these requirements cannot be achieved due to operating limits, such as pumping limit, stop limit, allowable minimum and maximum speeds, axial forces/transverse forces on compressor bearings when both compressors are running. In this case, if the pressure is too high, too little reaction water is removed, thereby water accumulates and after some time the fuel cells are flooded so that the oxygen supply breaks down and consequently cell voltages and the supplied current collapse.

As the compressor driven by a turbine requires sufficient enthalpy and thus also pressure at a turbine inlet to maintain its operation, the lower allowable speed limit may be reached, for example, if the pressure is too low.

### SUMMARY

The object of the invention is therefore to propose an improved method for starting a fuel cell system where low pressures can also be realized if they are required or desired.

A method for starting a fuel cell system is proposed, wherein the fuel cell system comprises at least one fuel cell stack and a compressor arrangement that has a first compressor, which is coupled to an electric motor, and a second compressor, which is coupled to a turbine arranged in a cathode path of the fuel cell system, the method having the steps of detecting a starting condition in the form of a requested pressure level for the at least one fuel cell stack and/or a temperature level of the at least one fuel cell stack and/or the start type of the at least one fuel cell stack; deciding on the basis of the starting condition whether the compressor arrangement is started in a first start mode with delayed start of the second compressor, or in a second start mode with non-delayed start of the second compressor; in the first start mode, starting the first compressor and accelerating until an idling speed of the first compressor is exceeded and a predetermined first maximum start speed is reached at most, starting the at least one fuel cell stack, operating the at least one fuel cell stack at a maximum with a partial load, checking the temperature level of the at least one fuel cell stack and/or the requested pressure level for the at least one fuel cell stack and starting the second compressor after exceeding a corresponding threshold value and accelerating until an idling speed of the second compressor is exceeded and a predetermined second maximum start speed is reached at most, and operating the at least one fuel cell stack until the intended maximum load, once the first and second compressors are operating properly; in the second start mode, starting the first compressor and the second compressor and respectively accelerating and starting the at least one fuel cell stack, and operating the at least one fuel cell stack up to the intended maximum load once the first and second compressors are operating properly.

The method according to the invention is capable of starting the fuel cell system and, in particular, the compressor arrangement such that modes of operation that require a low system pressure in the cathode path of the fuel cell stack can be taken into account very easily.

This could require, for example, a start at freezing temperatures of below 0° C., a cold start of just above 0° C., a warm-up phase up to a target operating temperature, operating the fuel cell stack below the target operating temperature (e.g., cooling due to too low a load, such as when driving downhill and at low ambient temperature), or drying processes of the fuel cell stack during shutdown, recuperation functions with low pressure functions. The compressor arrangement may still have an electrically operated compressor and a turbine-operated compressor, as is common in the prior art. The compressor arrangement may be started such that low cathode pressures are adjustable near ambient pressure by delaying the start of the turbine-driven compressor when the electric compressor is started or operated.

Parallel to the two start modes, the fuel cell system as a whole may also operate in a first or second operating state that takes into account the first or second start mode. In the first operating state, the output of the at least one fuel cell stack may be reduced to a partial load and, for example, transferred to the second operating state upon reaching a sufficient operating temperature in which both compressors operate and the at least one fuel cell stack can be operated up to the maximum load.

This can achieve better coordination of operation between the at least one fuel cell stack and the compressor arrangement. Water management in the fuel cell system is improved and flooding of fuel cells is avoided. Overall, the aging of the at least one stack of fuel cells is avoided or reduced and the overall efficiency of the fuel cell system is improved.

If the start of the second compressor fails when the speed of the second compressor remains at zero or the idling speed is not reached, the system remains in partial load operation until another start of the second compressor is attempted, if necessary.

In one advantageous embodiment, the method further comprises opening a second compressor bypass arranged parallel to the second compressor when the first compressor is started while the second compressor is stopped and closing the second compressor bypass when the second compressor is started. Higher airflow in the compressor arrangement may be generated by the second compressor bypass. As a result, the fuel cell system experiences fewer lower limitations during operation, as the mass flow of the compressor arrangement can be largely directed around the second compressor, which has a positive effect both on the pumping limit of the first compressor and on the transverse and axial forces of the second compressor.

In one advantageous embodiment, the starting condition is detected predictively or in real time by evaluating at least one physical variable detectable by a sensor and/or based on a simulation of the physical variable. This may be a requested pressure level or temperature of the at least one fuel cell stack, as stated above. The latter could be estimated or simulated by a mathematical model, for example.

In an advantageous embodiment, the at least one physical variable comprises a coolant temperature of the at least one fuel cell stack. This may be measured by a coolant temperature sensor and provides information about the temperature inside the fuel cell stack.

In an advantageous embodiment, in the first start mode, during acceleration of the first compressor, compressed air supplied by the first compressor flows through the second compressor, wherein the second compressor is locked and/or wherein the speed of the first compressor is limited to a predetermined partial load speed. Transverse forces and axial forces exerted on the stopped second compressor by the flow though it may thereby be limited to avoid damage. The stopped second compressor is an obstruction and causes a pressure drop. The pumping limit of the first compressor is thereby reached more quickly than when the second compressor is in active operation. The limitation to the partial load speed may be realized in a simple manner by significantly restricting the operation of the first compressor compared to operation with the second compressor running. Alternatively, the forces could also be calculated from current thermodynamic data, and thus the limitation of the partial load speed could be calculated based on a model.

In one advantageous embodiment, before the second compressor is started and after the second compressor bypass is closed, the speed of the first compressor is limited to a speed which results in an enthalpy of a cathode exhaust air flow that exceeds a maximum 10% enthalpy required to start the second compressor. As a result, the enthalpy is sufficient for the start of the second compressor, but at the same time the axial and transverse forces are also limited to the second compressor.

In one, advantageous embodiment, the operation of the second compressor is interrupted if the requested pressure level cannot be achieved during simultaneous operation of first compressor and the second compressor, but is always exceeded. If the pressure level for a meaningful water management is to be below the minimum pressure of the compressor arrangement with both compressors running, the second compressor must be turned off again. To prevent a repeated shutdown and start of the second compressor, the decision to shut down can be realized with a hysteresis function. Furthermore, the decision could also be made to be dependent on modes of operation, for example it is necessary to have low pressures close to ambient pressure in the at least one fuel cell stack in order to dry the at least one fuel cell stack upon shutdown.

The invention further relates to a fuel cell system having at least one fuel cell stack, a compressor arrangement, the at least one electrically operable first compressor and a downstream or upstream second compressor which is coupled to a turbine arranged in a cathode path of the fuel cell system, and a control unit for controlling the fuel cell system, wherein the fuel cell system is configured to carry out a method for starting the fuel cell system by means of the control unit.

It should again be noted that the topological order of the compressors plays no role in carrying out the solution according to the invention.

In an advantageous embodiment, the fuel cell system further has a second compressor bypass arranged parallel to the second compressor, wherein the control unit is configured to open the second compressor bypass when the first compressor is started in the first start mode while the second compressor stopped and to close it when the second compressor is started.

In an advantageous embodiment, the fuel cell system further comprises a turbine bypass arranged in parallel with the turbine, wherein the control unit is configured to open the turbine bypass when the first compressor is started in the first start mode.

### BRIEF DESCRIPTION OF THE DRAWINGS

Further measures for improving the invention are described in greater detail hereinafter, together with the description of the preferred exemplary embodiments of the invention, with reference to the figures.

Shown are:

FIG. 1 a schematic view of the fuel cell system in an exemplary compressor sequence;

FIG. 2 a schematic, block-based representation of aspects of the method;

FIG. 3 a schematic, block-based representation of further aspects of the method.

### DETAILED DESCRIPTION

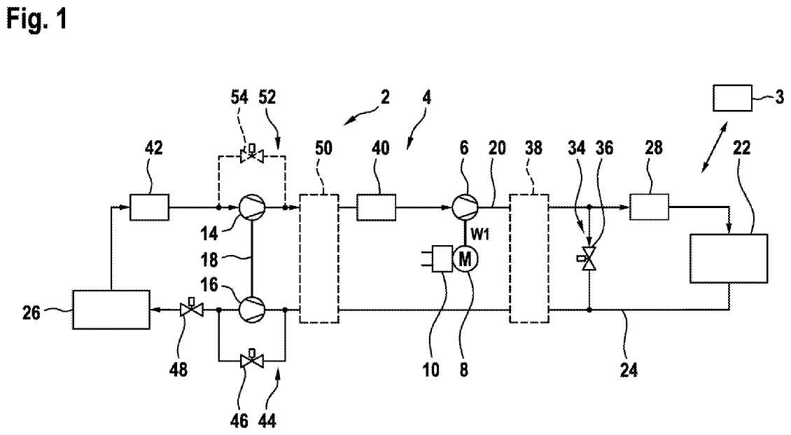

FIG. 1 shows a fuel cell system 2 that is controlled via a control unit 3. The fuel cell system 2 has a compressor arrangement 4, which comprises a first compressor unit 6 with an electric motor 8 and an inverter 10. The first compressor 6 is connected via a shaft 12 to the motor 8, which is supplied with an operating voltage via the inverter 10. The inverter 10 could be controlled externally to adjust the rotational speed of the motor 8 as required. The first compressor 6 is designed as the second compression stage here, and a second compressor 14 is designed as the first compression stage here. This represents the first stage of the entire air compression process.

The second compressor 14 and a turbine 16 driving said compressor are coupled to each other by a second shaft 18. The second compressor 14 is located downstream of the first compressor 6 and supplies compressed air into an incoming air path 20 of a fuel cell stack 22.

Outgoing air from the fuel cell stack 22 flows into an outgoing air path 24 and from there into the turbine 16. The outgoing air can then flow downstream of the turbine 16 into the environment 26. The incoming air path 20 and the outgoing air path 24 can be combined as a cathode path.

An intercooler 28 is also provided downstream of the second compressor 14, which cools the compressed incoming air before it enters the fuel cell stack 22. A first shut-off valve 30 is located downstream of the intercooler 28, which shuts off the incoming air flow into the fuel cell stack 22 as required. A second shut-off valve 32 is located downstream of the fuel cell stack 2 for interrupting a connection between the fuel cell stack 22 and the outgoing air path 24 as required. The fuel cell stack 22 can be bypassed via a fuel cell bypass 34. The fuel cell bypass 34 has a fuel cell bypass valve 36 that can be opened and closed as required.

A heat exchanger 38 can be provided between the fuel cell stack 22 and the second compressor 14, which transfers heat from the incoming air path 20 to the outgoing air path 24.

An additional intercooler 40 could also be arranged between the first compressor 6 and the second compressor unit 14, which cools the air flowing into the second compressor 14. An air filter 42 is arranged upstream of the first compressor unit 6, which filters air from the environment 26 and feeds it to the first compressor 6. The turbine 16 can be bypassed by a turbine bypass 44. The turbine bypass 44 has a turbine bypass valve 46 that can be opened and closed as required. An outgoing air shut-off valve 48 is also provided downstream of the turbine 16. A further heat exchanger 50 could be arranged directly downstream of this, which absorbs heat from the part of the incoming air path 20 directly downstream of the first compressor 6 and transfers it to the outflowing exhaust air. A second compressor bypass 52 having a second compressor bypass valve 54 is arranged parallel to the second compressor 14. The second compressor 14 can thereby be bypassed with compressed air from the first compressor 6.

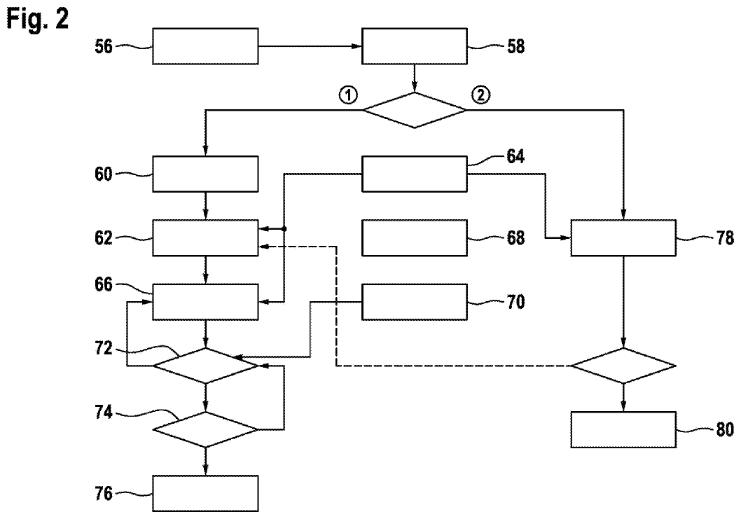

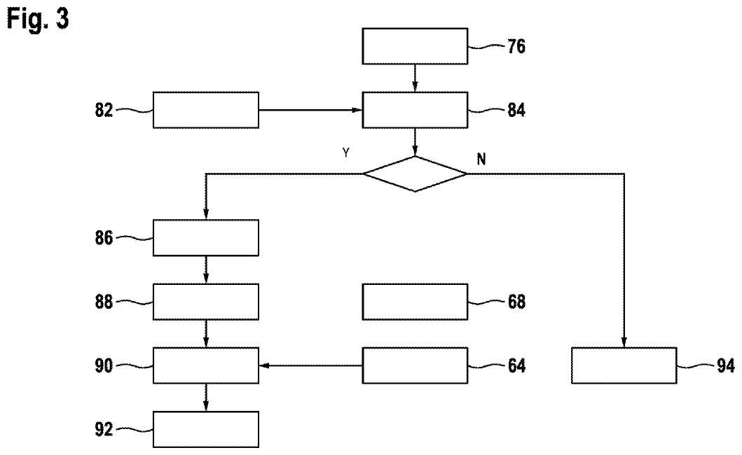

The fuel cell system 2 is capable of being controlled by the controller 3 to carry out a method for starting the fuel cell system 2, which is explained in more detail in FIGS. 2 and 3.

FIG. 2 shows aspects of the method in a schematic, block-based illustration. First, a starting condition is detected 56 to subsequently decide 58 whether to start the compressor arrangement 4 in a first start mode or a second start mode. If the temperature of the fuel cell stack 22 is too low, a cold start or start at freezing temperatures is provided. If a low pressure is provided, the first start mode with delayed start of the second compressor 14 is selected.

For the first starting condition, the shut-off valves 30 and 32 are closed, the cathode bypass 34 and turbine bypass 44 as well as second compressor bypass 52 are opened, which may be referred to as de-throttling 60. The first compressor 6 is started 62 and accelerated, taking limitations 64 into account, up to a predetermined partial load speed which is to be tolerated when the second compressor 14 is switched off. The transverse and axial forces exerted on the stopped second compressor 14 by the flow through it—insofar as this is the case at all due to the second compressor bypass 52—can be restricted by limiting the speed. In addition, the pumping limit of the first compressor 6 is also not reached.

The fuel cell stack 22 is started 66 and operated taking the limitations into account, wherein the shut-off valves 30 and 32 are opened and the cathode bypass 34 is closed. Limited operation of the first compressor 6 at partial load speed results in a maximum possible partial load mass flow, resulting in a maximum possible partial electrical output of the fuel cell stack 22. This is less for systems without a second compressor bypass 52 than for systems with a second compressor bypass 52. However, this partial power is usually sufficient for the relevant cases such as starting at freezing temperatures and cold start. The target power and thus also the warmup gradient are to be limited in the first start mode.

The state and operation of the second compressor 14 is then continuously monitored 68, in particular to ensure that the second compressor 14 is not rotating or to take into account that it is rotating. During rotation, the speed of the first compressor 6 could be decreased if necessary.

The fuel cell stack temperature is still continuously checked 70. Based on this, a decision can be made 72 as to when the second compressor 14 is to be put into operation 74. This may also be done at a correspondingly higher required pressure level. Since the temperature changes slowly in the warm-up phase and a warm-up gradient can be detected or also controlled, the start of the second compressor 14 can also be predicted. For example, if the temperature of the coolant at the outlet of the fuel cell stack 22 is greater than 50° C., the second compressor 14 may be started. Since the start can take place quickly, the switchover is dynamically uncritical.

The fuel cell stack 22 may then, after successfully starting the second compressor 14, operate normally up to full load 76, depending on common limits applicable to the fuel cell system 2.

If the second start mode is provided, the first compressor 6 and the second compressor 14 are started simultaneously 78. The turbine bypass 44 is closed so that the second compressor 14 starts with the first compressor 6. If present, the second compressor bypass 52 is also closed. If the second compressor 14 does not start, e.g., due to a blocked shaft, then limited operation as in method step 62 can be adopted. On the other hand, conventional operation may be started 80.

Further aspects of the method are shown in FIG. 3. Based on operating conditions 82, a decision is made 84 as to whether second compressor 14 should be switched off, such as when the compressor arrangement 4 cannot meet a low pressure requirement. This is preferably done with a corresponding hysteresis. If an earlier stop of the second compressor 14 is desired, the compressor arrangement 4 is transferred to an idling state 86 so that the second compressor 14 is not switched off at a high load point. The speed of the second compressor 14 should only be marginally higher than an idling speed. Thereafter, a shutdown 88 occurs. In order to shut down the compressor 14 with turbine 16, the turbine bypass 44 is opened and, if present, the compressor bypass 52 is also opened. The first compressor 6 and the fuel cell stack 22 then continue to operate 90, wherein the speed of the first compressor 6 is to be matched to the absence of the second compressor 14 and other limitations 64, respectively.

To end operation of the fuel cell system 2, the output of the fuel cell stack 22 is reduced. If no more mass air flow is required, i.e. not for the fuel cell stack 22, not for dilution of the residual hydrogen or otherwise, then the first compressor 6 is switched off 92.

If the shutdown of the second compressor 14 is not preferred, then both compressors 6 and 14 are switched off 94 simultaneously.

The two methods can be combined. For short start-stop phases, it may not be necessary to start the second compressor so that the second compressor may also remain shut off. This also has advantages for reducing bearing wear.

Monitoring 68 of the operation of the second compressor 14 is also useful in this part of the method.

In addition, it should be noted that, in contrast to FIG. 1, the order of the compressor stages can also be selected differently.

1. A method for starting a fuel cell system (2) with at least one fuel cell stack (22) and a compressor arrangement (4) that has a first compressor (6), which is coupled to an electric motor (8), and a second compressor (14), which is coupled to a turbine (16) arranged in a cathode path of the fuel cell system (2), the method having the following steps:
detecting (56) a starting condition in the form of a requested pressure level for the at least one fuel cell stack (22) and/or a temperature level of the at least one fuel cell stack (22) and/or the start type of the at least one fuel cell stack (22),
deciding (58) based on the starting condition whether the compressor arrangement (4) is started in a first start mode with delayed start of the second compressor (14), or in a second start mode with non-delayed start of the second compressor (14),
in the first start mode, starting (62) the first compressor (6) and accelerating until an idling speed of the first compressor (6) is exceeded and a predetermined first maximum start speed is reached at most, starting (66) the at least one fuel cell stack (22), operating the at least one fuel cell stack (22) at a maximum with a partial load, checking (70) the temperature level of the at least one fuel cell stack (22) and/or the requested pressure level for the at least one fuel cell stack (22) and starting (74) the second compressor (14) after exceeding a corresponding threshold value and accelerating until an idling speed of the second compressor (14) is exceeded and a predetermined second maximum start speed is reached at most, and operating (76) the at least one fuel cell stack (22) up to the intended maximum load, once the first and second compressors (6, 14) are operating properly,
in the second start mode, starting (78) the first compressor (6) and the second compressor (14) and respectively accelerating and starting the at least one fuel cell stack, and operating (80) the at least one fuel cell stack (22) up to the intended maximum load once the first and second compressors (6, 14) are operating properly.

2. The method according to claim 1,
further comprising opening a second compressor bypass (52) arranged parallel to the second compressor (14) when the first compressor (6) is started in the first start mode while the second compressor (14) is stopped and closing the second compressor bypass (52) when the second compressor (14) is started.

3. The method according to claim 1,
wherein detecting (56) the starting condition is performed predictively or in real time by evaluating at least one physical variable detectable by a sensor and/or based on a simulation of the physical variable.

4. The method according to claim 3,
wherein the at least one physical variable comprises a coolant temperature of the at least one fuel cell stack (22).

5. The method according to claim 1,
wherein in the first start mode, during acceleration of the first compressor (6), compressed air supplied by the first compressor flows at least partially through the second compressor (14),
wherein the second compressor (14) is locked and/or the speed of the first compressor (6) is limited to a predetermined partial load speed.

6. The method according to claim 2,
wherein before the second compressor (14) is started and after the second compressor bypass (52) is closed, the first compressor (6) is brought to a speed which results in an enthalpy of a cathode exhaust air flow which ensures an enthalpy required to start the second compressor (14).

7. The method according to claim 1,
wherein the operation of the second compressor (14) is interrupted if the requested pressure level cannot be achieved during simultaneous operation of first compressor (6) and the second compressor (14), but is always exceeded.

8. A fuel cell system (2), having:
at least one fuel cell stack (22),
a compressor arrangement (4) which has at least one electrically operable first compressor (6) and a downstream or upstream second compressor (14) which is coupled to a turbine (16) arranged in a cathode path of the fuel cell system (2), and
a control unit for controlling the fuel cell system, wherein the fuel cell system is configured to carry out a method for starting the fuel cell system by means of the control unit according to claim 1.

9. The fuel cell system (2) according to claim 8,
further having a second compressor bypass (52) arranged parallel to the second compressor (14),
wherein the control unit (3) is configured to open the second compressor bypass (52) when the first compressor (6) is started in the first start mode while the second compressor (14) is stopped and to close it when the second compressor (14) is started, and also to open it when the second compressor (14) is to be stopped from operating both compressors.

10. The fuel cell system (2) according to claim 8,
further having a turbine bypass (44) arranged parallel to the turbine (16),
wherein the control unit (3) is configured to open the turbine bypass (44) when the first compressor (6) is started in the first start mode and to close it when the second compressor (14) should be started,
and also to open it when the second compressor (14) is to be stopped from operating both compressors.
